(19) United States
(12) Patent Application Publication
(10) Pub. No.: US 2010/0094467 A1
(43) Pub. Date: Apr. 15, 2010

(54) ENERGY SAVING SYSTEM

(75) Inventor: Hiroyuki Kakiuchi, Yokohama (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/491,956

(22) Filed: Jun. 25, 2009

(30) Foreign Application Priority Data
Oct. 15, 2008 (JP) 2008-265879

(51) Int. Cl. G06F 1/32; G05D 23/19

(52) U.S. Cl. 700/276; 700/295

(57) ABSTRACT

An energy saving system acquires seat occupation information from a database of a seat occupation management system, detects equipment appliances of the places at which personnel are not seated, on the basis of the seat occupation information and transmits control information based on the detection result to an equipment control system so that unnecessary equipment appliances of the places where the personnel do not exist can be turned off. The energy saving linking system executes a processing for calculating optimal position and range in accordance with the seat occupation information, calculates an area providing the highest movement efficiency to overtime personnel and displays the calculation result.

### INCORPORATION BY REFERENCE

The present application claims priority from Japanese application JP 2008-265879 filed on Oct. 15, 2008, the content of which is hereby incorporated by reference into this application.

### BACKGROUND OF THE INVENTION

This invention relates to a linking system of an equipment control system for environmental equipment appliances such as air conditioning equipment or illumination equipment in accordance with seat occupying positions of seat occupying personnel with a seat allocation system capable of calculating seat allocation of persons moving in accordance with a certain object and displaying the seats allocated. More particularly, the invention relates to a control system that links (combines) these systems to one another and promotes saving of energy and resources of the equipment appliances.

Innovation has taken place in recent years in the work styles of enterprises with the progress of network systems and with the progress of communication appliances typifed by IP telephone. It is the work style referred to as “free address” that does not provide a fixed seat to each personnel but allows the personnel to work every day on an arbitrary desk. According to this work style, each personnel can freely change the seat according to the mood of the day or with the business project and a layout-free office style becomes possible.

However, a new problem that it is rather difficult to grasp quickly who is seated at which seat has arisen in the office introducing the free address style. This is because the personnel can similarly carry out the work even in a different building or a different floor as long as the office has the similar free address style.

To solve the problem, JP-A-2007-335923 and JP-A-2008-140295 describe a seat occupation management system. The system of these patent documents displays at which seat of which floor of an office a user using a terminal is seated, on the basis of terminal connection information from a network appliance such as an LAN switch. In consequence, it becomes possible to easily grasp from a display diagram (display screen) shown in FIG. 9 of JP-A-2007-335923 who is seated at which seat and thus to solve the problem described above.

On the other hand, various equipment control systems capable of conducting either automatically or on the control center side the centralized management of illumination appliances and air conditioning appliances by utilizing sensor technologies in office buildings, etc, have been proposed. For example, the technologies include those which arrange various sensors on each floor and make the operation control of the air conditioning appliances on the basis of the sensor information, detect the absence/existence of persons and cut off the power source of the illumination appliances of each floor. Such technologies have drawn an increasing attention from the aspect of environmental protection such as saving of energy and electric power. As for the control of the air conditioning equipment in office buildings, in particular, the technologies have the feature that the control can be made more efficiently and more finely by using an input value of the sensor information etc.

JP-A-2004-205202 describes an example. The technology conducts the operation control of the air conditioning appliance on the basis of the sensor information and information from means for inputting sensorial comfortableness of seat occupying persons.

JP-A-2002-295885 describes the technology that can execute the control in accordance with an action schedule when a user registers beforehand the action schedule to the system besides the sensor information.

On the other hand, a so-called “seat allocation system” that allocates seats by taking a certain specific condition into consideration is known. This system is mainly directed to accept reservation of seats by taking request and convenience of clients into consideration when accepting the seat reservation of trains and airplanes and JP-A-2000-76352, in particular, describes a concrete processing system for optimizing the seat allocation.

The seat allocation optimization method of this patent document divides the seat allocation problem into a seat utilization zone division/decision problem and a passenger seat allocation problem, and solves each problem. The former problem is to decide in which partial zone the seat utilization is made for those seats which remain continuously unoccupied for a certain zone and the latter is to conduct the seat allocation of the passengers after the utilization zone of each vacant seat is decided.

As for the seat allocation methods of vacant seats other than the seat allocation in the trains, only a few are known that are based on simple rules such as allocation of seats to a designated seat zone and sequential allocation of seats from a side whenever a seat allocation request arises. Therefore, a new seat allocation technology has been required to meet with the demand when the free address style office described above is combined with the effort for saving energy and electric power.

For example, an attempt has been made to limit an overtime work area requiring illumination and air conditioning when personnel do the overtime work beyond a certain time after a fixed time in a free address office by causing all the personnel working overtime in respective floors to move and gather into a specific floor to achieve saving of energy and electric power. To conduct such an attempt, the existing situation in offices is such that an overtime start time and an overtime work area (place and range) are determined in advance as a common rule inside the office and personnel working overtime move to the overtime work space when the designated time is reached.

In this instance, the attempt described above will be promoted and will become wide spread if the system is available which system detects the seat occupation condition of all floors at a designated time, allocates the seats with the minimum movement burden to the personnel and contributes to saving of both energy and electric power.

### SUMMARY OF THE INVENTION

The equipment control system of the prior art that controls the air conditioning appliances and the illumination appliances on the basis of the information from various kinds of sensors first needs the information from the sensors. To precisely control the air conditioning appliances and the illumination appliances, a large number of sensors must be arranged inside the office. Therefore, this system involves the problems that the cost of the sensors and their installation expenses are extremely high.

To reduce the costs as much as possible, JP-A-2004-205202 and JP-A-2002-295885 propose the technologies using sensors etc. but require more less the installation of the sensors. To reduce the number of installation positions and to save the trouble and cost of the installation, novel substitute means must be prepared and this again invites new cost and trouble while imposing the burden to the users.

More concretely, JP-A-2004-205202 needs to arrange afresh “means for inputting comfortableness of seat occupying persons” and a new work arises for the user to input a daily action schedule to the means. JP-A-2002-295885 also requires to arrange afresh “means for inputting action schedule of user” and requires the user to input his or her daily action schedule with the inputting means.

Let's consider from another aspect the attempt to save energy and electric power in an office of the free address style by causing after a fixed time those personnel who work overtime in specific floors to move to a designated overtime work area so as to reduce the work area requiring the illumination equipment and the air conditioning equipment. According to the prior system based on the common rule described in the background of the invention, the time and the overtime work space (place and range) must be determined in advance. When the number of personnel who have to do overtime work owing to the term-end is large, for example, the problem may occur that the number of seats of the overtime work space decided in advance is not sufficient and when the number of the personnel working overtime is by far smaller than expected, on the contrary, the overtime work space becomes unnecessarily large. Thus, this system lacks practical flexibility.

When air conditioning and illumination are compulsively cut off at a predetermined time in combination with the equipment control system in the case given above, saving of energy and electric power can be achieved reliably, it is true, but this method invites a variety of problems. For example, personnel who intend to finish their works within five to ten more minutes or who are just talking with clients over the phone are compulsively urged to cut off the works or to move to the overtime work space and the problems such as the deterioration of business efficiency, the drop of customer image and the increase of frustration of personnel occur.

Even when the majority of the personnel working overtime are those of the sections at the remotest place from the overtime work space in the case described above, many of them have to suspend the work and to move to the overtime work space because the work space is designated beforehand.

In connection with setting of such an overtime work space, JP-A-2000-76352 relating to the optimization of the seat allocation might be effective for the seat allocation in the train services but is not applicable to the energy/electric power saving system because the object and environment are entirely different.

In view of the problems described above, it is a first object of the invention to solve various kinds of problems in the installation of sensors and the problems of substitute technologies by effectively utilizing database information of a seat occupation management system for managing seat occupation positions of users using information processing apparatuses and personal computers (PC) and by controlling an equipment control system in accordance with the existence or absence of personnel (users).

In an attempt to save energy/electric power in a free address office, it is a second object of the invention to provide a seat allocation method that reduces a movement burden to seat occupying personnel and a method for reporting the calculation result by the former method to the seat occupying personnel.

An embodiment of the invention for solving the problems described above acquires seat occupation information from a database of a seat occupation management system, acquires also operation information and installation position information of equipment appliances from a database of an equipment control system, provides a processing for judging an operating condition of illumination and air conditioning appliances at positions at which seat occupying personnel do not exist, by using the information acquired as input values, a processing for detecting equipment appliances kept on irrespective of the absence of the seat occupying personnel and a processing for generating control information such as turn-off of the power source of the equipment appliances detected and thus transmits the information to the installation control system.

In an attempt to save energy/electric power in a free address office, another embodiment of the invention provides a processing for acquiring a seat occupation condition of each floor from the seat occupation management system when a designated time after a fixed time is reached, and calculating an optimal position that minimizes the movement distance of moving personnel in accordance with the seat occupation condition and a suitable range in accordance with the number of the seat occupation personnel and can display the calculation result.

An energy saving linking system according to still another embodiment of the invention includes a PC equipped with means capable of receiving messages through a network that is used by personnel and displaying the reception content, compares seat occupation information acquired from the seat occupation management system with area information through a server, judges whether or not the position of the PC is within the area and reports the message corresponding to the judgment result.

The invention can provide a system that can automatically judge the existence/absence of personnel by only external database information for managing position information of the personnel typified by a seat occupation management system irrespective of the existence/absence of sensors and the number of the sensors, automatically turns off the power source of illumination equipment and air conditioning equipment at positions at which the personnel are not present, and is optimal for saving energy/electric power.

In a work style for promoting energy/electric power saving, the invention can provide a system capable of assisting the personnel to conduct the attempt more easily and more reliably.

Other objects, features and advantages of the invention will become apparent from the following description of the embodiments of the invention taken in conjunction with the accompanying drawings.

### BRIEF DESCRIPTION OF THE DRAWINGS

FIG. 1 is a block view showing a structural example of an energy saving linking system for executing the invention;

FIG. 2 is a table showing an example of information recorded to a database of a seat occupation management system;

FIG. 3 is a map diagram of an html format depicted by the seat occupation management system;

FIG. 4 is a block diagram showing an example of a real layout of illumination equipment and air conditioning equipment;

FIG. 5 is a table showing an example of information recorded to a database of an equipment control system;

FIG. 6 is a first block diagram showing a functional construction of a linking server for executing the invention;

FIG. 7 is a first flowchart showing a processing of the linking server for executing the invention;

FIG. 8 is a second block diagram showing a functional construction of a linking server for executing the invention;

FIG. 9 is a second flowchart showing a processing of the linking server for executing the invention;

FIG. 10 is a bar graph for judging a distribution condition of seats;

FIG. 11 is a table showing an example of condition information;

FIG. 12 is a table showing a first display window example for displaying work area information for overtime work;

FIG. 13 is a table showing a second display window example for displaying work area information for overtime work;

FIG. 14 is a third block diagram showing a functional construction of the linking server for executing the invention; and

FIG. 15 is a third flowchart showing a processing of the linking server side for executing the invention.

### DESCRIPTION OF THE EMBODIMENTS

The embodiments of the invention will be hereinafter explained with reference to the accompanying drawings.

### Embodiment 1

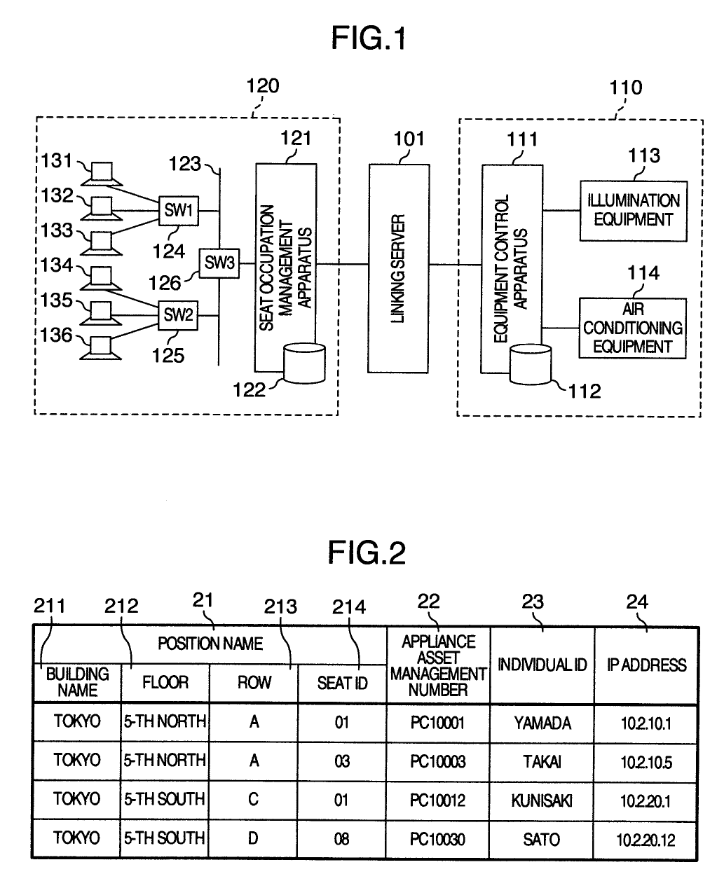

FIG. 1 is a basic system construction view for executing an embodiment of the invention. In the drawing, reference numeral 110 denotes an equipment control system. This system includes illumination equipment such as fluorescent lamps, air conditioning equipment 114 such as air conditioners, an equipment control apparatus 111 for controlling these kinds of equipment and a database 112 for managing information such as an the operating conditions of the equipment appliances and their installation positions. The equipment may well be information apparatuses such as printers and information appliances other than the illumination appliances and air conditioning appliances.

The equipment control system 110 keeps the information of the equipment appliances the system manages and controls by itself in the database 112 and access can be made from outside to the information of the database 112 through an interface provided to the equipment control apparatus 111. The system can also control each equipment appliance from the equipment control apparatus 111 when a control command for designating the equipment control system is sent to the interface of the equipment control apparatus 111.

On the other hand, reference numeral 120 denotes a seat occupation management system. This system 120 includes PC (information terminals) 131 to 136 connected to the system through LAN 123, LAN switches 124 to 126 for connecting the PCs to the LAN, a seat occupation management apparatus 121 and a database 122.

The seat occupation management system 120 keeps in the database those kinds of information that link the installation positions of the information terminals managed by itself with the users and access can be made from outside to the information of the database 122 through an interface provided to the seat occupation management apparatus 121.

The PCs 131 to 136 managed by the seat occupation management system 120 have means for reporting IP address information of their own and individual ID information of the terminal users to the seat occupation management apparatus 121 and the reported information is recorded to the database 122. The PCs 131 to 136 further have means capable of receiving the message through the network and automatically displaying the reception content. When the seat occupation management apparatus 121 sends the message information to the PC 131 by using the IP address information held by the database 122, for example, the PC 131 can receive the message and display the reception content on the display window.

Incidentally, both of the equipment control system 110 and the seat occupation control system 120 described above are those systems which can be materialized by using the known system technologies such as the technology of JP-A-2007-335923 and their detail will be hereby omitted. When the linking server 101 for executing the processing as the feature of this invention that can be connected to both systems through the network is constituted, the illumination appliances and the air conditioning appliances can be controlled on the basis of the seat occupation information.

FIG. 2 shows an example of information stored in the database 122. This database 122 is prepared by re-arranging the database shown in FIG. 21 of JP-A-2007-335923 filed previously by the inventors of the invention so that it can be used more easily for the present invention. More concretely, the position name 21 is further fragmented into a building name 211, a floor name 212 and a seat ID 214 to more finely manage the seat occupation. In addition, model information is omitted because it is not necessary in this embodiment. Instead, a column 213 for recording the IP address information of the terminal of its own sent from the PCs 131 to 136 is added as already explained with reference to FIG. 1. Reference numeral 22 denotes an appliance asset management number, reference numeral 23 denotes an individual ID and reference numeral 24 denotes information representing the IP address.

This database information is information that is generated by the seat occupation management system 120 from connection information from the network appliances such as the LAN switches and the various kinds of management information managed by the system 120 by itself. The seat occupation management apparatus 121 displays the seat list information to the users of the seat occupation management system 120 by writing the information in the map diagram of the html format, for example.

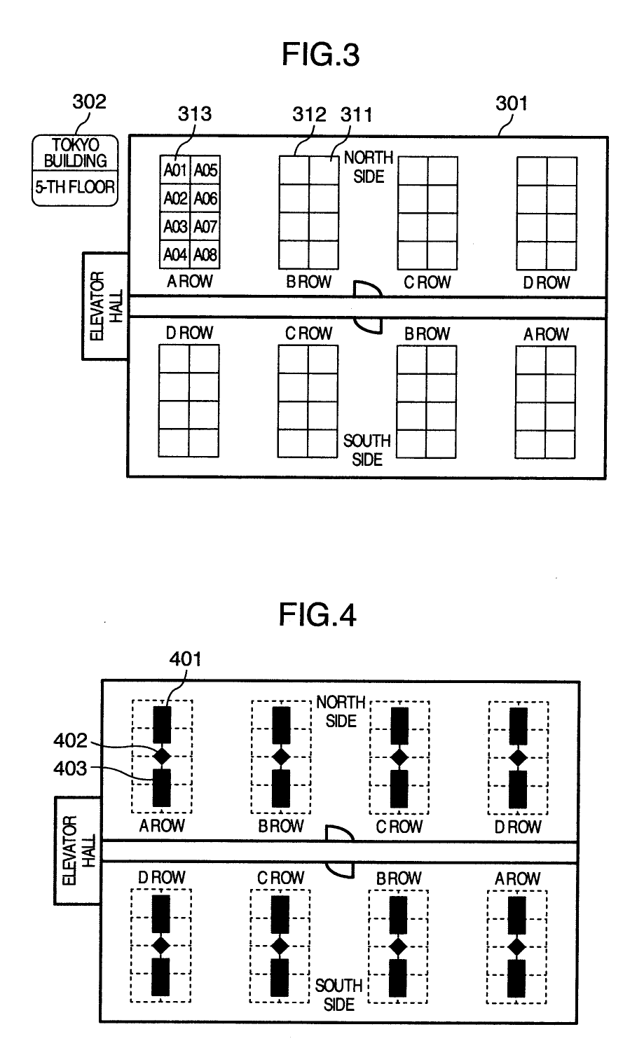

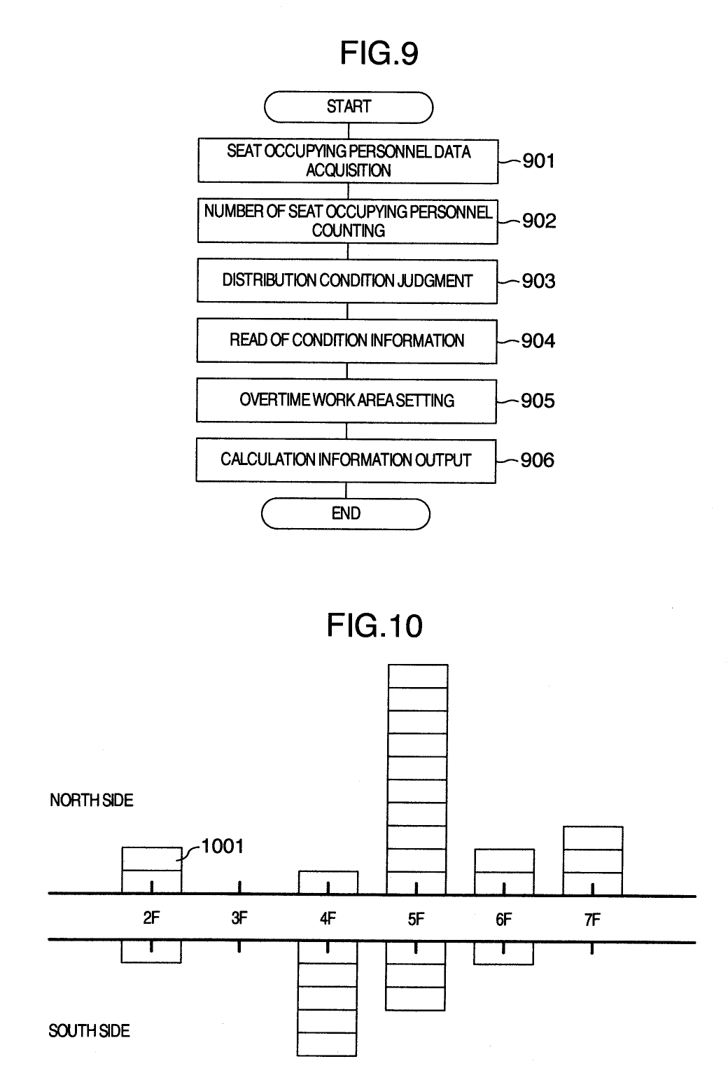

FIG. 3 shows an example of the map diagram of the html format. This map is prepared by re-arranging FIG. 9 of the afore-mentioned JP-A-2007-335923 for ease of illustration of this embodiment. The map diagram is depicted and managed by the seat occupation management apparatus 121 and visually displays the seat occupation information that is managed by the database 122. Reference numeral 301 denotes a plan view of an office and desks 311 are arranged in accordance with an actual layout. Reference numeral 312 denotes an island in which the desks 311 are arranged. Reference numeral 302 denotes an area for comprehensively displaying a building name and a display floor. A seat ID 313 is buried invisibly to the users into the frame of each desk diagram and the individual ID can be displayed on this seat frame by matching this seat ID 313 with the seat ID of the database 122 (FIG. 2).

FIG. 4 shows an actual layout of the illumination appliances and the air conditioning appliances. Fluorescent lamps 401 and 403 and an air conditioner 402 are installed in each island of each floor as shown in the drawing. It will be assumed, for example, that the fluorescent lamp 401 is arranged on the window side of the A row, the fluorescent lamp 403, on the door side of the A row and the air conditioner 402, at the middle of the A row. Incidentally, a unique equipment appliance ID is set to each of the fluorescent lamp and the air conditioner and the appliance can be specified by using this ID information.

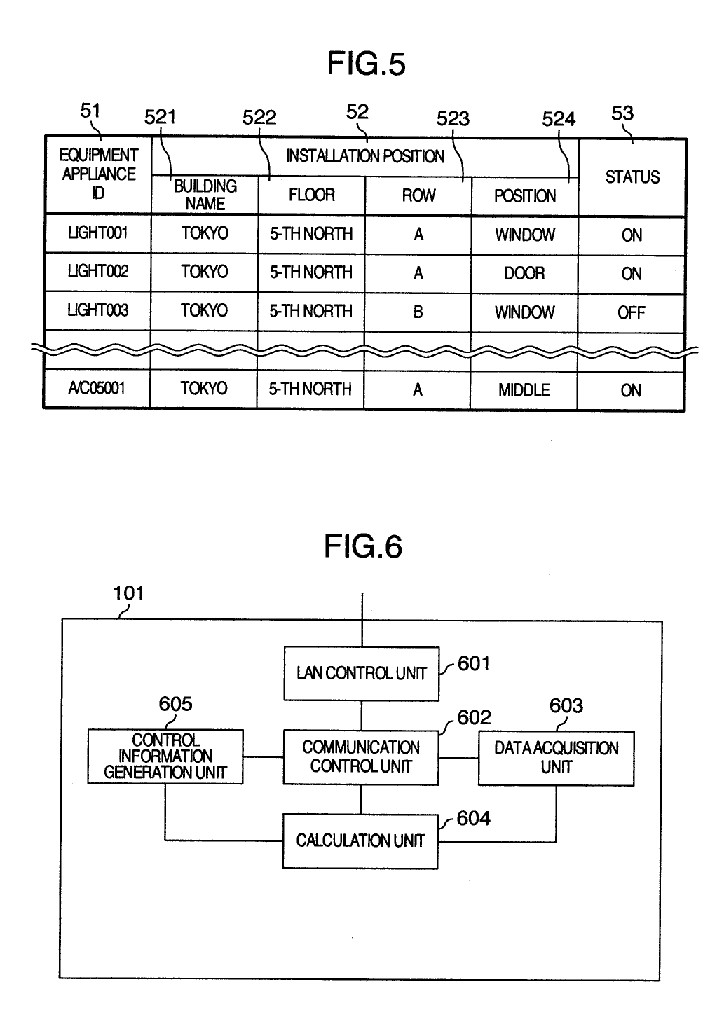

FIG. 5 shows an example of the information stored in the database 112 of the equipment control apparatus 111. The information includes equipment appliance ID information 51 for specifying an appliance in the control of each equipment appliance, physical installation position information 52 of the appliance (building name 521, floor 522, row 523, position 524) and status information 53 for recording the operating condition (ON/OFF) of the appliance. An appliance having ID of “LIGHT001”, for example, represents the fluorescent lamp installed on the window side of the A row on the north side of the fifth floor of “Tokyo Building” and its present status is ON. An appliance having ID of “A/C05001” represents the air conditioning appliance installed at the middle of the A row on the north side of the fifth floor of “Tokyo Building” and its present status is ON.

FIG. 6 is a block diagram showing a functional construction of the linking server 101 that constitutes the invention. In the drawing, the linking server 101 includes a LAN control unit 601, a communication control unit 602, a data acquisition unit 603, a calculation unit 604 and a control information generation unit 605 LAN control unit 601 has the function of controlling the network interface and the communication control unit 602 has the function of controlling data communication such as a protocol processing. The data acquisition unit 603 has the function of acquiring the database information through the interface of each of the equipment control system 110 and the seat occupation management system 120 and the calculation unit 604 has the function of conducting a calculation processing by using the information acquired from the network and various kinds of databases. The control information generation unit 605 has the function of generating a control command that the equipment control apparatus 111 can comprehend, on the basis of the result information calculated by the calculation unit 604.

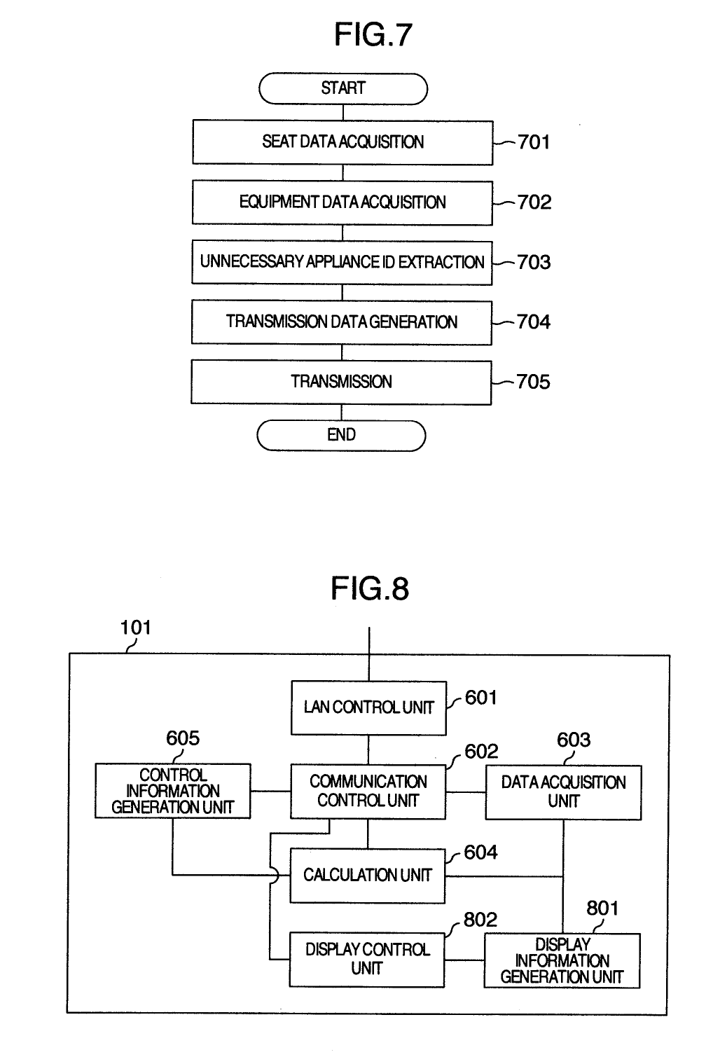

FIG. 7 shows a processing step executed in the calculation unit 604 of the linking server 101. The control command is transmitted to the equipment control system 110 by the processing step on the basis of the information from the seat occupation management system 120 and the equipment control system 110.

In this processing step, the processing is started every one hour after a fixed time, for example. In step 701, the seat occupation information at the present moment is acquired from the database 122 of the seat occupation management system 120 shown in FIG. 2 by using the data acquisition unit 603. In step 702, the equipment appliance the status of which is ON at the present moment is acquired from the database 112 of the seat equipment control system 110 shown in FIG. 5 by using the data acquisition unit 603. In step 703, the equipment appliance information is collated with the position information of the seat occupation information by using the installation position information as a key from the list of the equipment appliances under operation acquired and when the unnecessary equipment appliance is found it is extracted as the equipment appliance ID.

This processing step will be explained more concretely about the example shown in the drawings. The installation position information “Tokyo Building, fifth floor, north side, A row, window side” 51 of the equipment appliance ID=“LIGHT001” shown in FIG. 5 is extracted and whether or not this information matches with the position name information 21 of the seat occupying person information shown in FIG. 2 is judged. In this instance, the relation between “position in FIG. 5” and the “seat ID in FIG. 2” is defined in advance in such a manner as to neglect “window side=01 to 04, door side=05 to 08, middle side=seat ID”. Then, since the individual ID “Yamada” in FIG. 2 matches with “Takai”, it is possible to judge that the operation of LIGHT001 is normal. Similarly, as for the equipment appliance ID=“LIGHT002” in FIG. 5, the position in FIG. 5 is the door side and the door side 05 to 08 (seat ID in FIG. 2). Therefore, the personnel occupying the seat do not exist, and this appliance can be judged as the one the power source of which should be turned off, and its equipment appliance ID is extracted. The next equipment appliance ID=“LIGHT003” in FIG. 5 is skipped because its status is OFF and it is not the object of judgment. As for the equipment appliance ID=“A/C05001” in FIG. 5, the position=middle side in FIG. 5 and matching is calculated up to the row information. Since the personnel occupying the seat exist in the A row, it is possible to judge that the operation of A/C05001 is normal.

In the next step 704, the control command that the equipment control apparatus 111 can comprehend is generated by using the control information generation unit 605 for the equipment appliance ID extracted in the previous step for which the power source should be turned off. A concrete example will be explained on the basis of the explanation given above. Since LIGHT002 is the appliance the power source of which is to be turned OFF, the control command is converted to “LIGHT002=OFF” that the equipment control apparatus 111 can comprehend, for example, and is transmitted in the next step 705 to the equipment control apparatus 111 by using the communication control unit 602.

As explained above, the energy saving linking system in this embodiment acquires the seat occupation information from the seat occupation management system 120 and the operation information from the equipment control system 110, judges the operating condition of the illumination appliances and the air conditioning appliances of those portions at which the personnel is not present by using the information acquired as the input value, picks up the unnecessary equipment appliances that operate in the absence of the personnel, transmits the extraction result as the control command to the equipment control system 110 and materializes the energy/electric power saving effects.

According to the embodiment described above, it becomes possible to automatically detect the seat occupation condition in the units of the floor, the seat island and the desks where the personnel are absent and to turn off the switch of the unnecessary equipment apparatuses.

Though this embodiment represents the procedure for executing the processing shown in FIG. 7 by the independent linking server 101, the processing need not always be executed by the independent linking server but the processing constituting the linking server 101, for example, may well be incorporated in the seat occupation management apparatus 121 or in the environment control apparatus 111.

### Embodiment 2

Next, an energy saving linking system according to another embodiment of the invention will be described. The embodiment will be explained by the additional explanation to Embodiment 1.

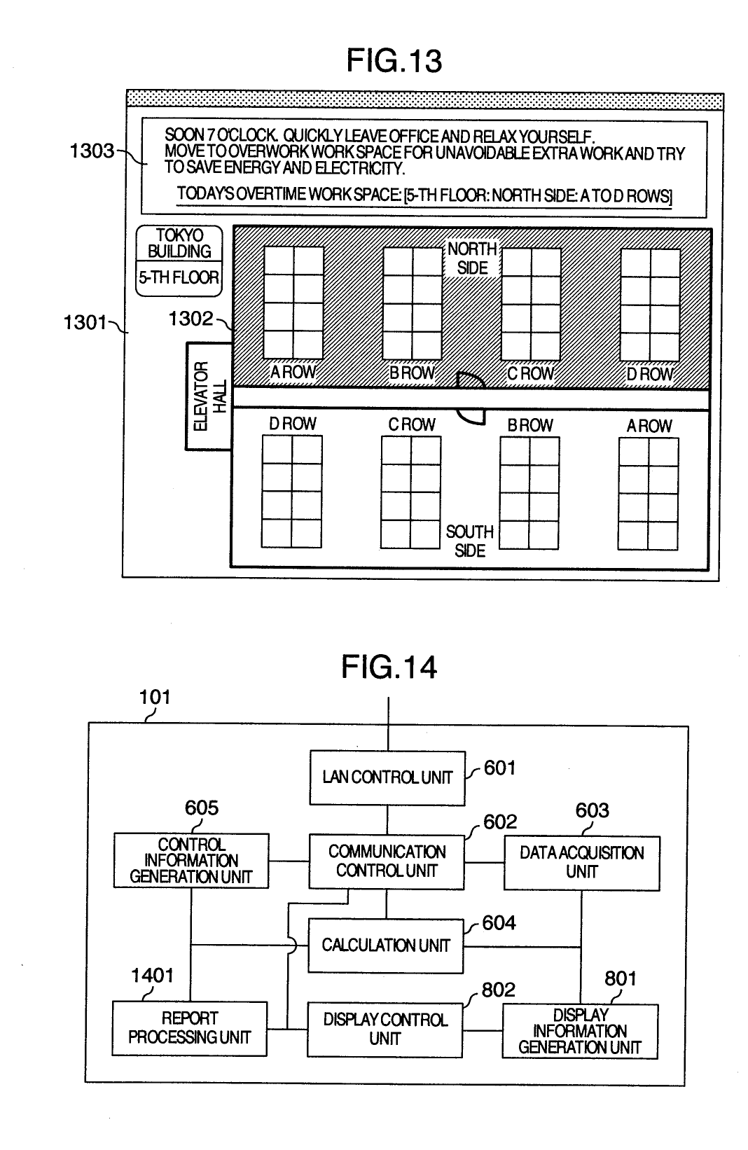

FIG. 8 is a logical structural view showing the functional construction of the linking server 101 explained with reference to FIG. 6 and a display information generation unit 801 and a display control unit 802 are added to this structural view. The display information generation unit 801 has the functions of receiving the calculation result information from the calculation unit 604 and converting the information into the display information that is easily comprehensive to the users. It has the functions of generating the display information shown in later-appearing FIGS. 12 and 13. The display control unit 802 has the functions of controlling the display information generated by the display information generation unit 801 in accordance with the request from the users.

FIG. 9 shows the processing step executed in the calculation unit 604 of the linking server 101. Incidentally, the calculation unit 604 can process either individually or simultaneously a plurality of processing steps. The processing step calculates the work area for the overtime work at a given point on the basis of the seat occupation information of the seat occupation management system 120 and delivers the information to the display information generation unit 801 for processing it into the user display information.

This processing step is started every hour after the fixed time, for example. In step 901, the seat occupation information is acquired from the database 122 of the seat occupation system 120 by using the data acquisition unit 603. In step 902, the present seat occupation number is counted from the information acquired and the distribution condition of the seat occupying personnel is counted for each floor or for each seat island in step 903.

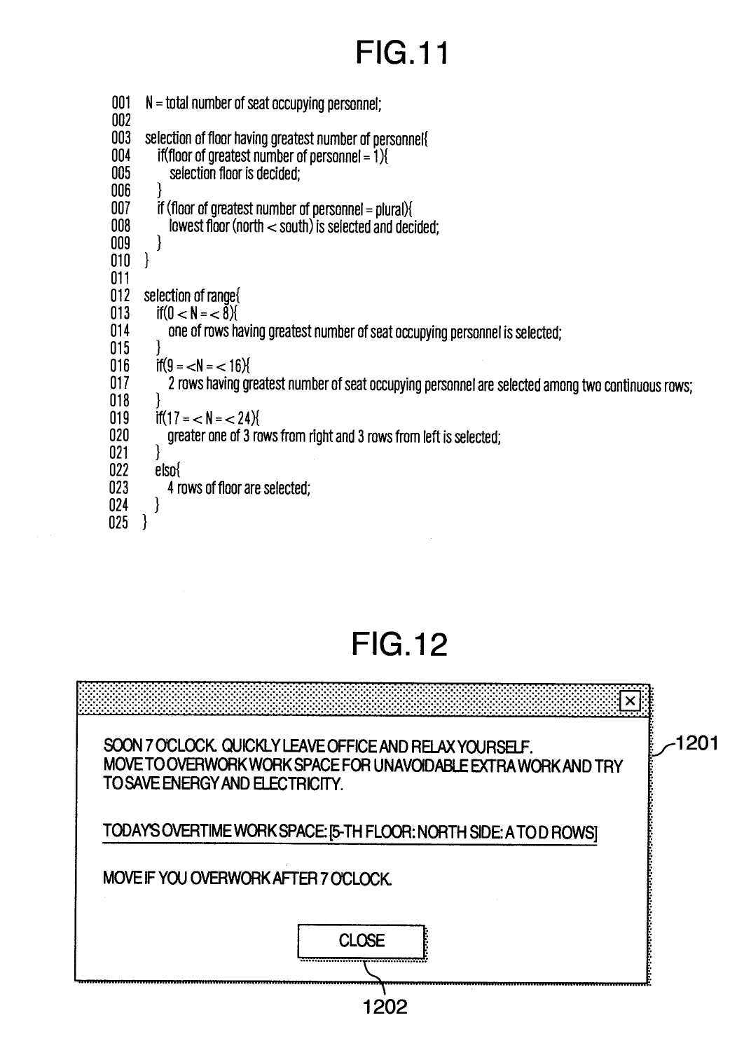

The processing of this step 903 will be explained in detail with reference to FIG. 10 and condition information for setting the work area for the overtime work is read in step 904. The condition information read in this step 904 will be explained in detail with reference to FIG. 11. In step 905 processing by the condition information is executed in step 905 to calculate the floor and the seat island to be set to the work area for the overtime work. In step 906, the work area information for the overtime work so decided is handed over to the display information generation unit 801.

FIG. 10 is a graphical diagram showing a number of boxes 1001 that correspond to the number of personnel and are stacked one upon another on the basis of the seat occupation information acquired from the database 122. Each floor is shown arranged in the transverse direction and the number of personnel existing on the floor is stacked upward on the north side floor and downward on the south side floor. This graph is for logically explaining the processing in the step 903. Such a graph is not outputted in practice but is calculated inside the system. When the distribution of the existing personnel corresponds to the result of this graph at a certain point of time, for example, it is possible to realize from this graph that the floor on which the greatest number of overtime personnel remains is the north side floor of the fifth floor.

FIG. 11 shows an example of the condition information read in the step 904. The drawing describes an example of the conditional text and an optimal overtime work area is calculated in accordance with the condition designated. The processing of this drawing will be explained more concretely with reference to FIG. 10. “N=28” in 001 and the greatest personnel number floor is one, that is, “fifth floor north side floor” in 003 to 010. Therefore, “Four rows of this floor are selected” in 012 to 025 is condition is the example described on the assumption that the number of overtime personnel is not greater than 30. When the conditional text is designated arbitrarily, the area selection can be made in accordance with the actual work environment of the users. When it is desired to always set the overtime work area to the second floor, for example, a conditional text for executing the optimal row judgment is described by conducting judgment from only the north/south side floor of the second floor in the floor selection. When two floors exist in which the number of personnel is remarkably great in the distribution condition in the step 903 in FIG. 9 and when the number of seat occupying personnel is greater than 80% of the total number of seats of one floor, for example, the conditional text may be described in such a manner that the two areas having the remarkably large number of personnel are set to the overtime work areas and the range is so specified as to accommodate the personnel in the floor having a smaller distance from the positions of the two floors.

FIG. 12 shows an example of display image of the message for transmitting the position of the overtime work area to the users. It is the information that the display information generation unit 801 generates on the basis of the overtime work area information handed over in the step 906 shown in FIG. 9. Reference numeral 1201 denotes a display window which is closed when a button 1202 is pushed.

FIG. 13 shows an example of display image in the same way as FIG. 12. The drawing represents a window example using a map diagram so that the users can grasp more readily. It is the information that the display information generation unit 801 generates on the basis of the overtime work area information handed over in the step 906 shown in the same way as described above. This example includes a window 1301 containing the map diagram, a portion 1302 for highlighting the overtime work area position calculated by hatching, etc, and text column 1303 representing character information.

The energy saving linking system explained above acquires the seat occupation information from the seat occupation management system 120 by using the functional construction shown in FIG. 8 and the processing step shown in FIG. 9 for calculating the overtime work space for energy/electric power saving, calculates the floor having the highest movement efficiency as the overtime work space in accordance with arbitrary condition information by using the seat occupation information as the input value and displays the calculation result to the users. Therefore, in the system in which those who do the overtime work beyond a designated time after the fixed time move to the designated work space, the embodiment can calculate the area having the best movement efficiency and can display the calculation result to the overtime personnel.

When the seats are allocated by calculating the overtime work area, this embodiment does not allocate the names of the personnel moving to the respective desks of the actual seat diagram but submits only the seat range corresponding to the number of seat occupation personnel because the explanation has been made about the free address office. Therefore, a system which describes concretely the names of the personnel moving to the desks may be used, too.

### Embodiment 3

Lastly, an energy saving linking system according to still another embodiment will be hereinafter described. The embodiment will be explained by the additional explanation to Embodiments 1 and 2.

FIG. 14 is a structural view when a report processing unit 1401 is added to the logical structural view of FIG. 8 that shows the functional construction of the linking server 101. The report processing unit 1401 has the function of sending a message representing the calculation result from the calculation unit 604 to the information terminal capable of receiving the message.

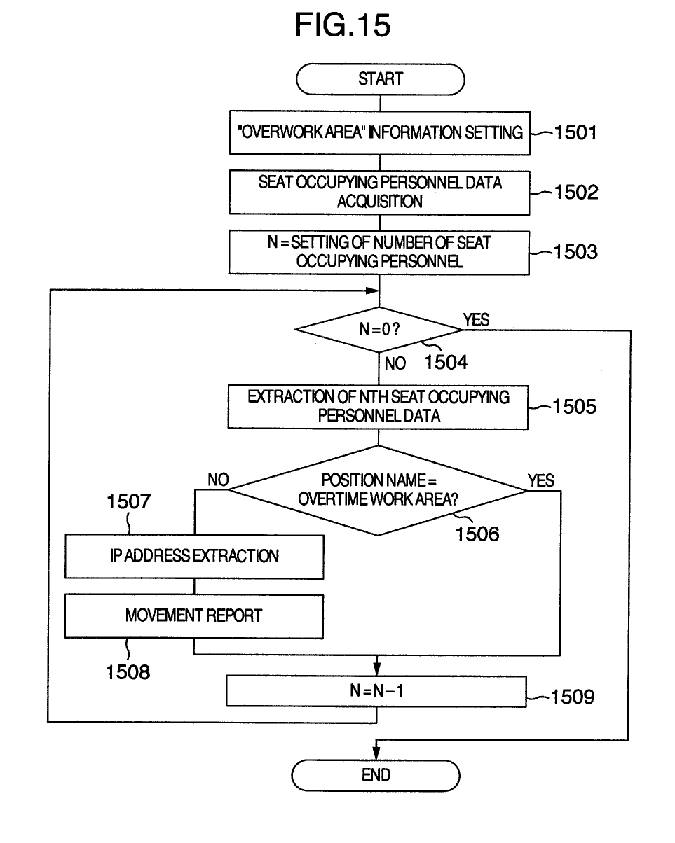

FIG. 15 shows the processing step executed by the calculation unit 604 of the linking server 101. This processing step judges whether or not each seat occupying personnel exists in the overtime work area on the basis of the seat occupying personnel information from the seat occupation management system 120, and sends the information of the overtime work area and the message urging the movement when the personnel does not exist in the overtime work area.

This processing is started 10 minutes before the movement starting time to the overtime work area, for example, and is thereafter repeated every hour. In step 1501, the information of “overtime work area” acquired by the processing in FIG. 9 is set and in step 1502 the seat occupation information is acquired from the database 122 of the seat occupation management system 120 by using the data acquisition unit 603. In step 1503, the table row number (=number of seat occupying personnel) of the seat occupying personnel data acquired in the preceding step is counted and is substituted for N. In step 1504, “N=0” is judged and when N is not 0 (step 1504—No), the Nth seat occupying personnel data is extracted in step 1505. In the next step 1506, whether or not the “position name” information (FIG. 2) of the extracted data and “overtime work area” information set in step 1501 are the same is judged. When they are the same (step 1506—Yes), the flow proceeds to step 1509. When not (step 1506—No), the IP address information (FIG. 2) of the PC is taken out from the extraction data in step 1507. In step 1508, the message is reported to the IP address information by using the report processing unit 1401.

The message to be reported hereby may be the information shown in FIG. 12 or only the URL information shown in FIG. 13 may be sent so that it can be displayed automatically by using browser software on the reception side. In step 1509, N−1 is substituted for N and the processing returns to step 1504 and is repeated until N=0 is attained. This processing is finished when N=0 in step 1504 (step 1504—Yes). The explanation will be given concretely about the example shown in the drawing. When the overtime work area is set to “fifth floor, north side floor, A row” in step 1501 and the data shown in FIG. 2 is acquired in step 1502, N=4 is attained in step 1503 and the seat ID=Sato is first extracted. Since the position name inside the extracted data is “fifth floor, south side floor, D row”, the position names are not coincident. Therefore, the flow proceeds to step 1507 and the IP address information “10.2.20.12” is taken out and the message is reported to this address in accordance with FIG. 12 or 13. This processing is thereafter repeated until N=0 is reached.

In the method for reporting the information to the seat occupying personnel or guiding the personnel in the system for saving energy/electric power explained above, the energy saving linking system of this embodiment judges whether or not the personnel is seated in the overtime work area at 10 minutes before the start of movement, automatically displays the approach of the movement starting time and the position information of the today's overtime work area on the screen when the personnel does not exist in the overtime work area and again executes the same processing after the passage of one hour from the movement starting time for those personnel who do not move, judges the seat occupying positions and automatically displays the message urging the movement on the screen.

Consequently, when there are those personnel who concentrate on the work and do not realize the movement time to the overtime work area or those who do not move after the passage of a long time from the designated time or those who once return to home but again enter the light-off floor and start working by turning on the lights, the energy saving linking system of this embodiment can judge the network connection positions of the PC used by those personnel, report the information for the overtime work space and urges their movement or guide them.

In the system for saving energy/electric power in enterprises and the like, the invention makes it possible to operate appropriate equipment appliances in accordance with the seat occupation information, to calculate the optimal overtime work area when the personnel do the overtime work, to transmit the proper overtime work area to the personnel to minimize their burden for the movement and to reliably accomplish energy/electric power saving.

It should be further understood by those skilled in the art that although the foregoing description has been made on embodiments of the invention, the invention is not limited thereto and various changes and modifications may be made without departing from the spirit of the invention and the scope of the appended claims.

1. An energy saving system comprising:
an equipment control system having means capable of executing control for equipment appliances inclusive of air conditioning equipment or illumination equipment through a network;
a seat occupation management system for specifying physical arrangement positions of terminals connected to network appliances on the basis of connection information to said network appliances and managing at which seat of which floor of an office a personnel using said terminal is seated; and
a server capable of being connected to both of said systems through the network,
wherein said server further includes means for acquiring operation information of said equipment appliances managed by said equipment control system, means for collating and analyzing the information acquired and means for transmitting the information analyzed to said equipment control system; and
wherein said energy saving system controls said equipment appliances on the basis of seat occupation information managed by said seat occupation management system.

2. The energy saving system according to claim 1, further comprising:
means for analyzing a seat occupation distribution at a certain point of time on the basis of the seat occupation information acquired from said seat occupation management system,
means for calculating a seat area providing high movement efficiency to the seat occupying personnel, and
means capable of displaying the calculation result.

3. The energy saving system according to claim 2 further comprising:
information terminals such as personal computers capable of being managed by said seat occupation management system and receiving a message and displaying a reception content through the network, and
means for comparing seat occupation information acquired from said seat occupation management system with the area information acquired, and judging whether or not the position of said information terminal is within said area and reporting a message corresponding to the judgment result to said server.
